(19) United States
(12) Patent Application Publication
(10) Pub. No.: US 2008/0215376 A1
(43) Pub. Date: Sep. 4, 2008

(54) LONG-TERM CARE INSURANCE

(76) Inventor: Lawrence Engelman, Oxford, CT (US)

Correspondence Address: MICHAUD-DUFFY GROUP LLP, 306 INDUSTRIAL PARK ROAD, SUITE 206, MIDDLETOWN, CT, 06457, US

(21) Appl. No.: 12/027,663

(22) Filed: Feb. 7, 2008

Related U.S. Application Data
(60) Provisional application No. 60/900,636, filed on Feb. 8, 2007.

(51) Int. Cl. G06Q 40/00; G06Q 20/00

(52) U.S. Cl. 705/4

(57) ABSTRACT

An insurance policy in which the initial maximum benefit payable under the policy is less than or equal to the premium. The policy protects an insured's assets under a Government benefit program that has an asset limit for applicants and that allows applicants to shelter assets by obtaining private insurance. Assets may be sheltered under such a Government program by providing such insurance, obtaining payment for a benefit under the insurance; and applying benefits under the Government program. Insurance can be sold to shelter assets under such a Government benefit program by setting the maximum payable benefit to less than or equal to the premium. Optionally, the initial maximum benefit payable under the policy is less than or equal to about 105% of the premium. The Government benefit program may be a Medicaid State Long-Term Care (LTC) Partnership Program and the insurance benefit may be a long-term health care benefit.

### CROSS-REFERENCE TO RELATED APPLICATIONS

This application claims the benefit of U.S. provisional application No. 60/900,636, filed Feb. 8, 2007, which is hereby incorporated herein by reference, in its entirety.

### FIELD OF THE INVENTION

This invention relates to insurance, and in particular to insurance designed to allow insured individuals to qualify for Government aid by sheltering assets and/or resources in an amount relating to the insurance benefit payments made to them or on their behalf. For example, this invention relates to long-term care insurance policies that permit insureds to shelter assets while qualifying for Medicaid benefits.

### BACKGROUND

Certain government aid programs run by the federal government of the United States of America and/or by state governments are available only those individuals who have no more than a stated amount of assets. However, qualifying applicants may sometimes lawfully shelter assets (i.e., qualify for Government aid despite having assets in excess of the stated threshold) by obtaining a specified type of insurance. For example, Medicaid provides payment to providers of long-term health care on behalf of qualifying individuals. The basic requirements for an individual to qualify for Medicaid long-term care benefits include that the individual not have more than a specific amount of assets. Unfortunately, the qualifying threshold or “asset limit” is so low (currently approximately $1,600.00) that Medicaid applicants generally must impoverish themselves before they qualify for Medicaid. They are thus deprived of enjoyment of the savings they accumulated during their life, of providing sufficient assets and income for their spouses and of the hope of leaving a significant inheritance for their next of kin. On the other hand, the availability of Medicaid provides a disincentive for people to obtain private long-term care insurance.

To provide an incentive to obtain private long-term care insurance, some states have adopted programs pursuant to Section 1917 (b) of the Social Security Act (42 U.S.C. §1396p), under which the qualifying asset threshold for a Medicaid applicant is raised to the extent that the applicant has obtained long-term care insurance and that the insurance has paid out benefits for care that Medicaid would cover. Such insurance policies typically have a limit, e.g. $100,000.00. Thus, an applicant whose insurer has paid $100,000.00 for long-term care would be allowed to qualify for Medicaid while still having $101,600.00 in assets when the asset limit would otherwise be $1,600. The insurance provides a “shelter” for the applicant's assets remaining after paying the insurance premiums. The applicant can thus receive Medicaid benefits and still have money for “extras” and to give to their spouse and next of kin, etc. Such programs are referred to as State Long-Term Care (LTC) Partnership Programs. federal rules allowing for LTC Partnership programs are set forth, at least in part, in the Deficit Reduction Act of 2005. The State of Connecticut's LTC Partnership Program, as well as programs in New York, California, and Indiana were approved by the Federal government several years ago. The Deficit Reduction Act allows additional states to adopt such programs. However, all currently available (“traditional”) long-term care insurance is subject to such stringent underwriting limitations based on health and age that many people who have significant savings and who are likely to require long-term care and wish to purchase long-term partnership policies do not even qualify or cannot afford the premium.

Accordingly, there remains an essential need for insurance, e.g., long-term care insurance, that will allow applicants to shelter their assets while still qualifying for Government aid, such as Medicaid, and that is affordable, and that is not laden with restrictions, such as age and health restrictions, that disqualify so many people.

### SUMMARY

The present invention resides in one aspect in an insurance policy comprising an insurance benefit for an insured, wherein the initial maximum benefit payable under the policy is less than or equal to the premium paid for the policy and wherein the policy qualifies to protect an insured's assets under a Government benefit program that has an asset limit for applicants and that allows applicants to shelter assets by obtaining private insurance.

In various illustrative embodiments, the Government benefit program may be a Medicaid State Long-Term Care (LTC) Partnership Program and the insurance benefit may be a long-term health care benefit.

The present invention resides in another aspect in a method for sheltering assets under a Government benefit program that has an asset limit for applicants and that allows applicants to shelter assets by obtaining private insurance. The method comprises providing an insurance policy for an insured as described herein, obtaining payment for a benefit under the insurance policy; and applying for payment of benefits under the Government benefit program.

In still another aspect, this invention provides a method for selling insurance. The method for selling comprises offering an insurance policy that qualifies to shelter assets under a Government benefit program that has an asset limit for applicants and that allows applicants to shelter assets by obtaining private insurance, and setting the initial maximum benefit payable to less than or equal to the premium.

In optional alternative embodiments, the initial maximum benefit payable under an insurance policy as described herein is less than or equal to about 105% of the premium paid for the policy.

### DETAILED DESCRIPTION

This invention provides low-risk insurance to allow insureds to shelter assets under Government aid programs that have asset limits for applicants and that allow applicants to shelter assets by obtaining private insurance. For example, this invention provides long-term care insurance that allows individuals to shelter assets under State Long-Term Care Partnership Programs. The insurance imposes minimal risk on the insurer, so the insurance can be offered to individuals subject to a minimum of qualifying limitations. Such insurance may be attractive to those who could not obtain affordable coverage under traditional long-term care policies.

According to one embodiment of this invention, insurance, such as long-term care insurance, is available under policies that limit the initial maximum benefit payable to less than the premium paid. As a result, the insurer has minimal risk and can provide coverage to individuals who are likely to make claims, e.g., those who are elderly and/or in poor health. The insurer uses the difference between the premium and the benefits to pay commissions and to finance its management operations. In some embodiments, this benefit structure substantially reduces underwriting risks from the perspective of one of ordinary skill in the art, thus allowing an insurer to invest significant proportions of premiums in low-risk securities such as U.S. Treasury bills, insured Certificates of Deposit, etc., and still realize a profit. Since there is so little risk to the insurer, the insurer need only take a minimum actuarial approach to developing a risk pool, and the insurance can be offered to a broad spectrum of the population on uniform terms or substantially similar pro-rata terms and to applicants who either cannot afford or qualify for traditional long-term care insurance policies. For example, in the case of long-term health care insurance, few policies are now written for individuals over 80 years of age. This invention allows State Long-Term Care Partnership Policies to be written to these individuals, who benefit by being able to obtain Government Medicaid benefits while sheltering other assets to the extent of benefits paid under this insurance.

In one embodiment, this invention is designed so that there is minimum risk to the insured. It is anticipated that most insureds have limited resources and would be unable to pay the premium unless substantial refund options existed. To minimize risks to the insured, insurance offered according to this embodiment may optionally include a cancellation feature under which, after an insured has paid a premium, he or she may cancel the policy and receive a refund of all or a substantial part of the premium, provided that no claim for benefits has been made. The insurance may also optionally offer a refund-on-death benefit under which a substantial portion of the premium paid will be refunded upon the insured's death, to the extent that benefits remain unpaid and the policy is still in force. Another optional feature that a policy might offer is an automatic inflation rider by which specified benefits increase over time based on a low rate index such as the return on a U.S. Treasury bill.

If applicable state or federal law requires an insurance policy to impose a minimum transfer of risk to the insurer that is not accomplished by setting the initial maximum benefit payable under the policy to less than or equal to the premium paid for the policy, the policy can be modified as needed. For example, the insurance may be sold through brokers, agents or other persons who become entitled to a sales commission upon providing the insurance policies, and applicants may be required to pay the commissions directly to such persons, so that the premium paid to the insurer is a separate payment that does not include a sales commission. In such case, the policy could be drafted so the initial maximum benefit payable under the policy may be slightly in excess of the initial premium paid, the possible excess imposing the requisite risk on the insurer. For example, the initial maximum benefit may be about 105% of the premium paid.

### EXAMPLE

The following is a sample policy designed to qualify as a LTC Partnership Insurance Policy and to provide Medicaid Asset Protection in the State of Connecticut. As reflected in the Outline of Coverage, the initial maximum benefit (about $85,000) is less than 85% of the initial premium (about $103,000).

Some state Medicaid programs and/or the new federal rules require that certain options or “riders” be made available, for example, an inflation-adjustment for daily and maximum benefits payable under the policy. Such Mandated Options may cause the insurer to be unable to underwrite long-term care policies without considering health and age issues because of the costs and insurance risks associated with such options. To allow the basic policies to be underwritten, such options, while being structured to be economically sound, may be priced unattractively or may be prohibited if one or more other more attractive options are elected, so that few applicants will request those mandated options. The policy also provides that the return of premium options cannot be elected if inflation or home care options are elected. For example, in the attached policy, the inflation-adjustment rider is available at a cost of $5,000.00 plus 4% of the Initial Maximum Benefit as defined in the sample Policy attached and cannot be purchased if any return of premium option is elected.

State and/or Federal law may require that long-term health insurance, when offered to applicants below a threshold age, must include certain inflation and home care benefits. The threshold age may differ from state to state. Generally, policies must provide a 5% minimum inflation benefit to applicants who do not exceed such ages. Such a benefit would impose a significant increase risk to the insurer in the event investment returns (on paid premiums) are less than the costs of inflation. If the policy was required to have an automatic inflation rider on the maximum benefit, the risk might be unattractive from the insurer's perspective, and the insurer may elect to decline to offer the insurance under such circumstances, or to offer the insurance and mitigate that aspect of the risk in another way.

The following sample policy does provide for an automatic inflation rider on the maximum benefit pool, based on a percentage of an index. This automatic inflation rider is less than the mandatory inflation rider that must be offered under state and federal law to all applicants who have not attained the minimum age. The automatic inflation provision allows for the maximum benefit over time to exceed the initial premiums and creates an insurance risk for the insurer.

It will be understood by one of ordinary skill in the art that modifications to the sample policy attached as Exhibit A may be made as needed to satisfy requirements for various state LTC Partnership programs or equivalent programs while incorporating the basic risk-avoidance features of this insurance product. Similarly, the Initial Maximum Benefit may fluctuate as a percentage of the premium and some policies may allow for the premium to be paid in several installments in lieu of an initial lump sum.

What is claimed is:

1. An insurance policy comprising an insurance benefit for an insured, wherein the initial maximum benefit payable under the policy is less than or equal to the premium paid for the policy, and wherein the policy qualifies to protect an insured's assets under a Government benefit program that has an asset limit for applicants and that allows applicants to shelter assets by obtaining private insurance.

2. The insurance policy of claim 1, wherein insurance benefit is a long-term health care benefit and the Government benefit program is a Medicaid State Long-Term Care (LTC) Partnership Program.

3. The insurance policy of claim 2, wherein the policy includes a return of premium death option in the amount of a substantial portion of the initial benefit remaining after payment of benefits.

4. The insurance policy of claim 2, wherein the policy includes a lifetime cancellation option in the amount of a substantial portion of the premium, provided that no claim for benefits has been made.

5. The insurance policy of claim 2, wherein eligibility is restricted to insureds who have attained a minimum age so that mandatory automatic inflation options on the maximum benefit pool need not be offered.

6. The insurance policy of claim 2, further comprising an automatic inflation adjustment benefit on the initial maximum benefit, which automatic inflation adjustment benefit is less than mandatory inflation benefits payable by law to all applicants who have not obtained statutory minimum age requirement.

7. A method for sheltering assets under a Government benefit program that has an asset limit for applicants and that allows applicants to shelter assets by obtaining private insurance, comprising:
providing an insurance policy for an insured;
obtaining payment for a benefit under the insurance policy; and
applying for payment of benefits under the Government benefit program;
characterized in that the initial maximum benefit payable under the policy is less than or equal to the premium paid for the policy.

8. The method of claim 7, wherein the Government benefit program is a Medicaid State Long-Term Care (LTC) Partnership Program, and wherein the insurance policy provides long-term health care insurance.

9. A method for selling insurance, comprising offering an insurance policy that qualifies to shelter assets under a Government benefit program that has an asset limit for applicants and that allows applicants to shelter assets by obtaining private insurance, and setting the maximum payable benefit to less than or equal to the premium.

10. The method of claim 9, wherein the insurance comprises long-term health care insurance and the Government benefit program is a Medicaid State Long-Term Care (LTC) Partnership Program.

11. An insurance policy comprising an insurance benefit for an insured, wherein the initial maximum benefit payable under the policy is less than or equal to about 105% of the premium paid for the policy, and wherein the policy qualifies to protect an insured's assets under a Government benefit program that has an asset limit for applicants and that allows applicants to shelter assets by obtaining private insurance.

12. The insurance policy of claim 11 wherein insurance benefit is a long-term health care benefit and the Government benefit program is a Medicaid State Long-Term Care (LTC) Partnership Program.

13. The insurance policy of claim 12, wherein the policy includes a return of premium death option in the amount of a substantial portion of the initial benefit remaining after payment of benefits.

14. The insurance policy of claim 12, wherein the policy includes a lifetime cancellation option in the amount of a substantial portion of the premium, provided that no claim for benefits has been made.

15. The insurance policy of claim 12, wherein eligibility is restricted to insureds who have attained a minimum age so that mandatory automatic inflation options on the maximum benefit pool need not be offered.

16. The insurance policy of claim 12, further comprising an automatic inflation adjustment benefit on the initial maximum benefit which benefit is less than mandatory inflation benefits payable by law to all applicants who have not obtained statutory minimum age requirement.

17. The insurance policy of claim 12, wherein the premium does not include a brokerage fee.

18. A method for sheltering assets under a Government benefit program that has an asset limit for applicants and that allows applicants to shelter assets by obtaining private insurance, the method comprising:
providing an insurance policy for an insured;
obtaining payment for a benefit under the insurance policy; and
applying for payment of benefits under the Government benefit program;
characterized in that the initial maximum benefit payable under the policy is less than or equal to about 105% of the premium paid for the policy.

19. The method of claim 18, wherein the Government benefit program is a Medicaid State Long-Term Care (LTC) Partnership Program, and wherein the insurance policy provides long-term health care insurance.

20. The method of claim 19, wherein providing long-term health care comprises paying a premium to an insurer and, separately, paying a brokerage fee to an insurance broker, agent or other person entitled to a sales commission upon providing the insurance policy.

21. A method for selling insurance, comprising offering an insurance policy that qualifies to shelter assets under a Government benefit program that has an asset limit for applicants and that allows applicants to shelter assets by obtaining private insurance, and setting the maximum payable benefit to less than or equal to about 105% of the premium.

22. The method of claim 21, wherein the insurance comprises long-term health care insurance and the Government benefit program is a Medicaid State Long-Term Care (LTC) Partnership Program.

23. The method of claim 22, wherein the premium does not include brokerage fees.
